(19) United States
(12) Patent Application Publication
(10) Pub. No.: US 2014/0160740 A1
(43) Pub. Date: Jun. 12, 2014

(54) LIGHT TUBE WITH LOW UP-LIGHT

(71) Applicant: AVAGO TECHNOLOGIES GENERAL IP (SINGAPORE) PTE. LTD., Singapore (SG)

(72) Inventors: Yi Feng Hwang, Penang (MY); Sian Tatt Lee, Penang (MY); Kwok Yuen Ng, Penang (MY); Chuan Hoe Chan, Perak (MY)

(73) Assignee: Avago Technologies General IP (Singapore) Pte. Ltd, Singapore (SG)

(21) Appl. No.: 13/710,445

(22) Filed: Dec. 10, 2012

(51) Int. Cl. F21V 13/00

(52) U.S. Cl. CPC F21V 13/00
USPC 362/218

(57) ABSTRACT

An illumination device, system, and method are disclosed. The illumination device includes a heat sink having a depression or channel established therein. One or more light sources can be mounted in the depression or channel and when light is emitted by the one or more light sources, the light can be directed or shaped by the depression or channel.

### FIELD OF THE DISCLOSURE

The present disclosure is generally directed toward light emitting devices.

### BACKGROUND

Light Emitting Diodes (LEDs) have many advantages over conventional light sources, such as incandescent, halogen and fluorescent lamps. These advantages include longer operating life, lower power consumption, and smaller size. Consequently, conventional light sources are increasingly being replaced with LEDs in traditional lighting applications. As an example, LEDs are currently being used in flashlights, camera flashes, traffic signal lights, automotive taillights and display devices. LEDs have also gained favor in residential, industrial, and retail lighting applications.

The replacement of fluorescent tubes with LED tubes is becoming much more commonplace. In particular, the LED-based solutions serve as a quick replacement to fluorescent tubes for energy conservation without the need of changing fixtures or troffers. Most LED tubes are cylindrical in shape and have bi-pin end caps at both ends just like fluorescent tubes.

### SUMMARY

The efficiency of a conventional troffer is quantified by its light output ratio (LOR). LOR is the ratio of luminous flux emitted by the troffer to the luminous flux emitted by the tubes inside. In other words, LOR gives the optical efficiency of the troffer. LOR for a normal troffer with fluorescent tubes is generally about 70%. This means 30% of the light emitted by the fluorescent tubes inside are lost in the troffer due to absorption losses at the reflector, leakage through gaps, absorption by the fluorescent tubes themselves, etc. The light loss is high because fluorescent tubes produce a significant amount of up-light. When LED tubes are mounted in a conventional troffer, LOR can be improved to about 85-90% due to smaller amount of up-light produced by the LED tubes. However, there are still 10-15% of light losses in the troffer if a traditional LED tube is used to replace the fluorescent light tube.

It is, therefore, one aspect of the present disclosure to provide an illumination device that overcomes the above-noted shortcomings. In particular, embodiments of the present disclosure introduce an illumination device that can achieve approximately <5% of light losses when utilized in a traditional troffer. Specifically, the illumination device is configured to focus its light downwards and produce as little up-light as possible, thereby minimizing losses associated with reflection and absorption in the troffer.

Another aspect of the present disclosure is to provide an illumination device that is capable of producing elongated light with a controllable viewing angle, thereby enabling the illumination of a large selected area.

Another aspect of the present disclosure is to provide an illumination device and system, which can reduce energy consumption, even when compared with current LED-based solutions. In particular, with better LOR, less light is required of the illumination device to produce the same amount of luminance and, thus, equivalent light can be produced with less energy.

For elongated narrow angle illumination, embodiments of the present disclosure can produce illumination results with higher uniformity over conventional narrow angle spot lights and with higher efficiency over fluorescent tubes and conventional LED tubes. Light with different beam angles can be made according to the desired illumination size or area.

In accordance with at least one embodiment, an illumination device is disclosed that includes a heat sink, a transparent or translucent plastic cover and 2 bi-pin end caps which can be fitted into existing fluorescent light fixtures. In some embodiments, multiple LED components are populated on one or more substrates such as Printed Circuit Boards (PCBs), which, in turn, can be mounted on the heat sink. In some embodiments, the heat sink includes two or more reflective surfaces and the two or more reflective surfaces can be configured to partially surround both sides of the substrate(s). It is contemplated that these reflective surfaces may form an angle of <180°, and can act as a reflector to focus light that is emitted by the LED components. The reflective surface(s) may include high reflectivity films to improve the optical efficiency of the overall system. In some embodiments, the cavity or channel formed by the reflective surface can be covered by a cover. In some embodiments, the height difference of the bottom surface of the plastic cover is approximately <5 mm to minimize the production of up-light.

The present disclosure will be further understood from the drawings and the following detailed description. Although this description sets forth specific details, it is understood that certain embodiments of the invention may be practiced without these specific details. It is also understood that in some instances, well-known circuits, components and techniques have not been shown in detail in order to avoid obscuring the understanding of the invention.

### BRIEF DESCRIPTION OF THE DRAWINGS

The present disclosure is described in conjunction with the appended figures:

FIG. 1 is a front view of an illuminated area in accordance with at least some embodiments of the present disclosure;

FIG. 2 is a side view of the illuminated area in accordance with embodiments of the present disclosure;

FIG. 3 is an isometric view of an illumination device in accordance with embodiments of the present disclosure;

FIG. 4 is a cross-sectional view of an illumination device in a lighting fixture in accordance with embodiments of the present disclosure;

FIG. 5 is a cross-sectional view of an illumination device in accordance with embodiments of the present disclosure;

FIG. 6 is a cross-sectional view of an illumination device in accordance with embodiments of the present disclosure; and

FIG. 7 is a flow chart depicting a method of installing and utilizing an illumination device in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is being understood that various changes may be made in the function and arrangement of elements without departing from the spirit and scope of the appended claims.

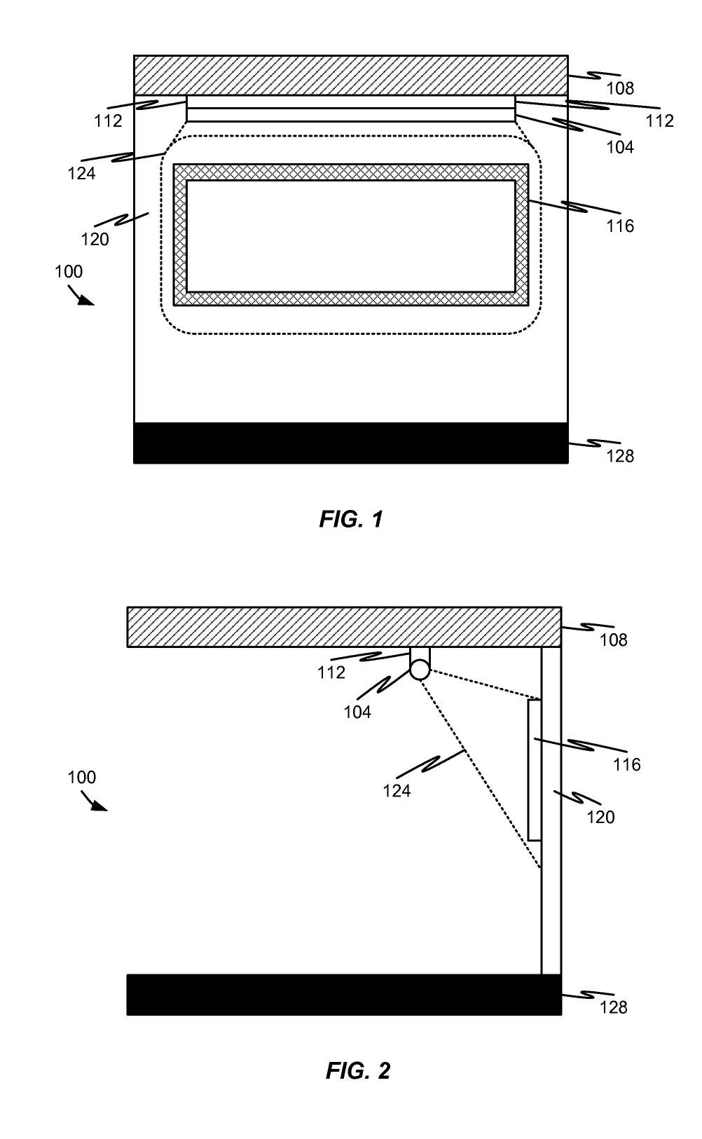

With reference now to FIGS. 1 and 2, an illustrative environment in which embodiments of the present disclosure can be employed will be described. It should be appreciated that while embodiments discussed herein are related to illuminating objects on a wall or vertical surface, embodiments of the present disclosure are not so limited. Rather, one or more concepts disclosed herein with respect to an illumination device, a lighting fixture including an illumination device, or the like, can be applied to any type of lighting application. The examples described herein are merely for reference and to assist in the understanding of the overall functionality of the present disclosure.

FIGS. 1 and 2 depict an illuminated area 100, which may correspond to a residential, commercial, retail, industrial, museum, fine art, or other type of illuminated area. The illuminated area 100 may include an illumination device 104 mounted to a ceiling 108 or the like with one or more mounting brackets 112. As will be discussed in further detail herein, the illumination device may alternatively, or additionally, be mounted to a ceiling 108 or the like vis-à-vis an already installed lighting fixture that may or may not have been designed to house a traditional fluorescent lighting tube. Advantageously, however, the illumination device 104 comprises one or more inherent light-directing structures, which may allow the illumination device 104 to be used in the illuminated area 100 without the assistance of a fixture that is designed to help focus light.

The illumination device 104 may be configured to emit light in a predetermined illumination profile 124 so as to illuminate one or more objects 116 on a wall 120, for example. Of course, the illumination device 104 may also be configured to emit its illumination profile 124 onto or toward the floor 128 and/or wall 120, depending upon the lighting effects desired for the illuminated area 100.

In a specific but non-limiting embodiment, the illuminated object 116 may correspond to a painting, work of art, shelving, or any other object that is desired to be illuminated. Advantageously, the illumination device 104 is capable of producing an illumination profile 124 that is relatively uniform across a substantial (e.g., uniform across more than the length of the illumination device 104 which can be 1-2 m in length. This illumination profile 124 is also directed/focused at the object 116, thereby decreasing the amount of energy required to adequately illuminate the object 116.

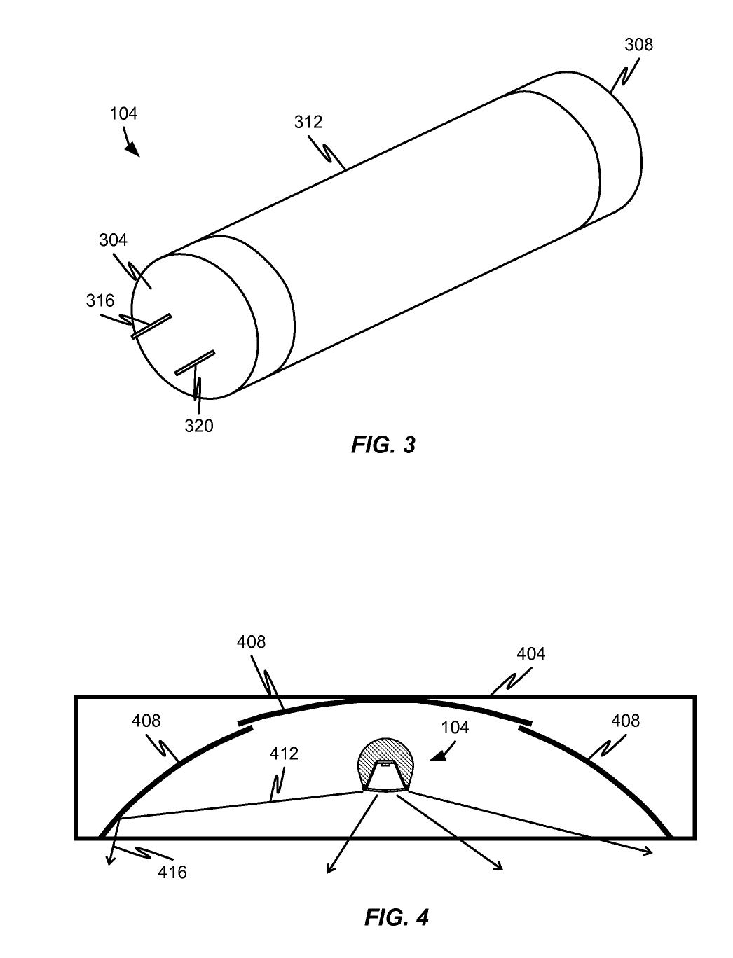

With reference now to FIG. 3, additional details of the illumination device 104 will be described in accordance with at least some embodiments of the present disclosure. The illumination device 104 may have a generally elongated tube-like shape, similar to existing fluorescent lighting tubes and LED-based lighting tubes. The illumination device 104 may comprise a first end 304, a second end 308, and a body portion 312 therebetween. The body portion 312 may be the portion of the illumination device 104 configured to emit light while the ends 304, 308 may be configured to interface with the mounting bracket(s) 112 and/or a lighting fixture. Furthermore, each end 304, 308 may comprise one or more pins 316, 320. The pins 316, 320 at each end of the illumination device 104 may be inserted into an electrical connector or the like and may carry electrical current to/from the light source(s) mounted along the body portion 312 of the illumination device 104. The ends 304, 308 and/or pins 316, 320 may be dimensioned to similar dimensions of the pins of conventional fluorescent tubes (e.g., G13 for T12/T10/T8 and G5 for T5).

It should be appreciated that the illumination device 104 may comprise more or less pins than depicted. For instance, each end 304, 308 may only have one pin. As another example, each end 304, 308 may have more than two pins. Further still, it is not a requirement that every pin be used to carry electrical current. Instead, one or more pins may be used solely for mechanical support.

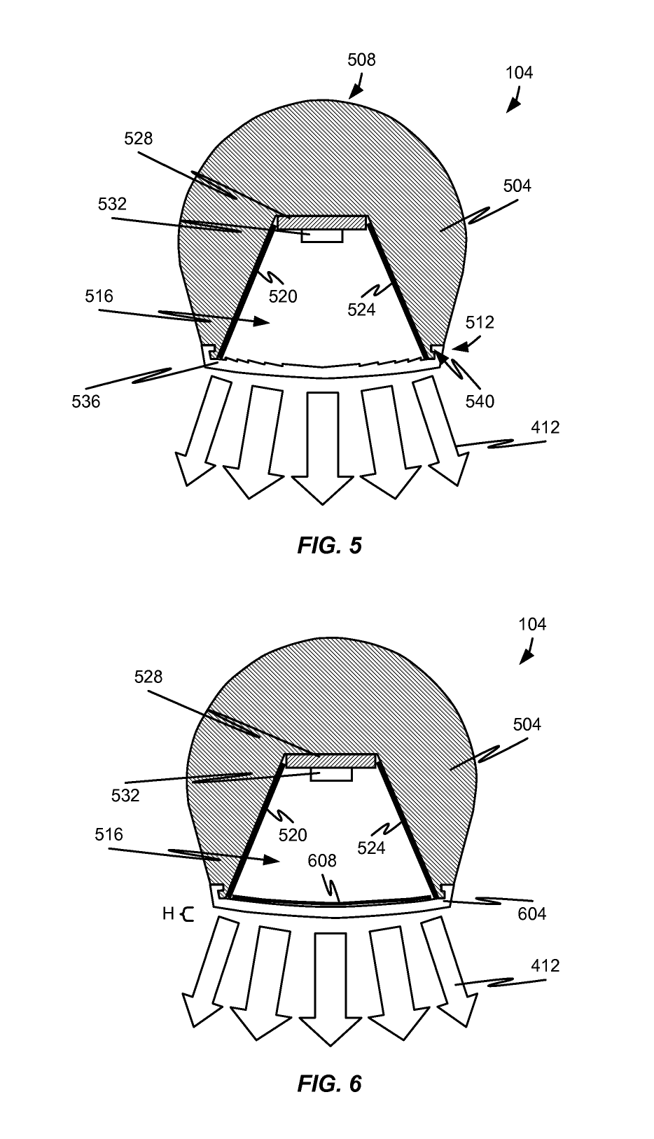

With reference now to FIG. 4, an illustrative lighting fixture 404 including an illumination device 104 will be described in accordance with at least some embodiments of the present disclosure. As noted above, it is not necessary to utilize an illumination device 104 in a lighting fixture 404; however, it may be desirable to utilize such a configuration when a room or building is already equipped with lighting fixtures 404 as it may provide the most cost-effective way to implement the improved illumination device 104.

In some embodiments, the lighting fixture 404 may correspond to a troffer or the like and may include one or more reflectors 408. The reflectors 408 of the fixture 404 may originally have been provided to reflect up-light produced by a fluorescent lighting tube, for example. As can be seen in FIG. 4, the illumination device 104 may be configured to produce emitted light 412 that is focused substantially downward. In other words, the reflectors 408 may remain in the fixture 404 as a historical artifact. However, some of the emitted light 412 may reflect off some lower portions of the reflectors 408, thereby resulting in a small amount of reflected light 416. This reflected light 416 is substantially all of the reflections that occurs at the fixture 404. The rest of the emitted light 412 is focused directly out of the fixture 404 onto an illuminated object 116.

With reference now to FIG. 5, additional details of an illumination device 104 having a first configuration will be described in accordance with at least some embodiments of the present disclosure. The depicted illumination device 104 may correspond to a tube-shaped device in that it has a length that is substantially greater than its width. In some embodiments, the illumination device 104 may be approximately 1-2 m in length.

In some embodiments, the illumination device 104 comprises a heat sink 504 having a top portion 508 and bottom portion 512. The heat sink 504 may be constructed of any material or combination of materials that is capable of transferring heat in an efficient manner. More specifically, the heat sink 504 may comprise a metal or aluminum alloy that is configured to disperse heat toward the outer curved surface of the heat sink 504. Although not depicted, the heat sink top portion 508 may comprise one or more heat dissipating elements (e.g., fins, ribs, grooves, etc.) to help increase the surface area of the heat sink top portion 508, thereby increasing the efficiency with which the heat sink 504 transfers heat to its environment.

In accordance with a generally tube-like shape, the heat sink top portion 508 is rounded, much like a fluorescent lighting tube. The heat sink bottom portion 512, however, may be flanged or transition from the curvature of the heat sink top portion 508 into a more straight line. In some embodiments, the heat sink 504 also comprises a depression or channel 516 that is open at the heat sink bottom portion 512. In some embodiments, the channel 516 traverses substantially the entirety of the body portion 312 of the illumination device 104.

The channel 516 may extend into the heat sink 504 such that its upper surface is closer to the heat sink top portion 508 rather than the heat sink bottom portion 512. In some embodiments, the top of the channel 516 may comprise a generally planar surface that is configured to receive and have mounted thereto a substrate 528. The substrate 528 may be configured to support or have mounted thereto one or more light sources 532. Like the channel 516, the top surface of the channel 516 may extend substantially across the entire body portion 312 and light sources 532 may be mounted along the same length.

In a specific but non-limiting embodiment, the top surface of the channel 516 may be substantially planar and the substrate 528 may correspond to a Printed Circuit Board (PCB) that is mounted, soldered, or affixed to the top surface of the channel 516. The substrate 528 may correspond to a rigid or flexible PCB. One function of the substrate 528 may be to provide a surface onto which the light source(s) 532 can be mounted. Another function of the substrate 528 may be to carry electrical current to/from the light source(s) 532, thereby enabling their functionality. More specifically, one or more leads on the substrate 528 may be connected to an external source of current or power via one or more of the pins 316, 320. Even more specifically, one or more of the pins 316, 320 may be electrically connected to in-wall wiring as well as one or more electrical traces in the substrate 528. One or more power transformers or power conditions may also be mounted to the substrate 528 to condition the power received at the pins 316, 320 for providing to the light source(s) 532. The traces of the substrate 528 may be configured to carry electrical current to the light source(s) 532, thereby enabling the light source(s) 532 to produce emitted light 412.

Any type of known light source may be used for the light sources 532. As some non-limiting examples, the light source(s) 532 may correspond to an LED, an array of LEDs, a laser diode, or the like. In some embodiments, a plurality of LEDs are mounted onto the substrate 528 and are configured to emit light when a voltage difference is applied across the anode and cathode of the LEDs. In some embodiments, the light source(s) 532 may comprise a thru-hole mount LED and/or surface mount LED. The light source(s) 532 may be mounted onto or thru the substrate 528 in a known fashion and then the substrate 528 may be mounted to the top surface of the channel 516 such that the light emitting surfaces of the light sources 532 are pointing toward the opening of the channel 516. Another type of light sources 532 that may be employed in accordance with embodiments of the present disclosure is an Organic LED (OLED) sheet or film. The OLED sheet or film may be mounted or adhered to the substrate 528. Alternatively or additionally, the OLED sheet or film may be mounted across the entirety of the top surface of the channel 516 as well as along one or both of the adjacent walls that establish the channel 516. The OLED sheet may have its electrodes connected to different leads that are either established on the substrate 528 or at some other portion of the illumination device 104.

Although not depicted, other electrical and electro-mechanical devices may also be mounted on the substrate 528. For instance, resistors, capacitors, inductors, transistors, sensors, motor components, etc. may be mounted on the substrate 528.

In some embodiments, the light source(s) 532 are configured to emit light 412 of a predetermined wavelength or color. More specifically, the light source(s) 532 may be configured to produce and emit light 412 that is approximately blue or Ultraviolet (e.g., with a wavelength of greater than approximately 445 nm), Infrared (e.g., with a wavelength between 1 mm and 750 nm), or any wavelength therebetween.

In some embodiments, the light source(s) 532 are configured to inherently produce heat during operation. The material of the heat sink 504 may be selected to help dissipate heat produced by the light source(s) 532 away from the light source(s) 532. More specifically, as noted above, the heat sink 504 may be made of aluminum or a similar type of material.

The channel 516 may also have two or more reflective walls 520, 524 that establish the side boundaries of the channel 516. One or both of the reflective walls 520, 524 may be made of or have applied thereto a reflective material to help decrease losses of light that is reflected by the walls 520, 524. As a non-limiting example, one or both walls 520, 524 may have a reflective film applied thereto along the length of the channel 516. The reflective material may be applied to the walls 520, 524 via an adhesive or the like. Alternatively or additionally, the reflective material may be sputtered or applied to the walls 520, 524 via one or more of Chemical Vapor Deposition (CVD), Atomic Layer Deposition (ALD), or the like. Although not depicted, some or all of the substrate 528 may have a reflective material to further increase the reflectivity within the channel 516.

Although the walls 520, 524 are depicted as being substantially flat or planar, it should be appreciated that the walls 520, 524 and/or top surface of the channel 516 may be non-planar. As an example, the walls 520, 524 may be curved inwardly or outwardly (continuously or discretely) to further help shape light reflected within the channel 516. Additionally or alternatively, the relative angle between the first reflective wall 520 and second reflective wall 524 may be any angel between approximately 0 degrees and 180 degrees and the dimensions of the channel 516 may be adjusted to accommodate various type of desired lighting effects.

In some embodiments, the channel 516 may be partially or completely filled with air or an ambient gas. In some embodiments, the channel 516 may be partially or completely filled with a non-gas material. As some examples, the channel 516 may be filled with a transparent or translucent material such as epoxy, silicone, a hybrid of silicone and epoxy, phosphor, a hybrid of phosphor and silicone, an amorphous polyamide resin or fluorocarbon, glass, plastic, or combinations thereof.

When the channel 516 is not completely filled with a solid material, the opening of the channel 516 may interface with a cover 536 or similar type of element. The cover 536 may provide many advantageous functions. As one example, the cover 536 may protect the light source(s) 532 from dirt, debris, and other ambient hazards. As another example, the cover 536 may provide light-shaping/light-directing functions. More specifically, the illustrative cover 536 may comprise one or more Fresnel lens elements incorporated therein. Moreover, the illustrative cover 536 may comprise a bend or domed shape to further minimize the amount of up-light produced. Specifically, the cover 536 may comprise a profile whereby its bottom surface is curved or non-linear and a height difference is established between the middle of the cover 536 and the points where the cover 536 interface with the heat sink bottom portion 512. In some embodiments, this height difference may be less than or equal to 5.0 mm or more particularly less than or equal to 2.5 mm.

The cover 536 may be manufactured of a transparent or translucent material that may be rigid or flexible. In some embodiments, the cover 536 correspond to a transparent plastic material that is non-rigidly flexible (e.g., polyethylene, polypropylene, polystyrene, polyvinyl chloride, polytetrafluoroethylene (PTFE), etc.). The Fresnel lens elements of the cover 536 may further help direct light downward as well as soften the light before it exits the illumination device 104.

In the depicted embodiment, the cover 536 interfaces with the heat sink bottom portion 512 with a snap fit 540. It should be appreciated that other mechanical or non-mechanical mechanisms can be used to connect the cover 536 with the heat sink 504. For instance, adhesives, welding, glue, friction fit, snaps, rivets, buttons, or the like can be used to fasten or secure the cover 536 to the heat sink 504.

With reference now to FIG. 6, another configuration of an illumination device 104 will be described in accordance with at least some embodiments of the present disclosure. The illumination device 104 of FIG. 6 is shown to include a cover 604 with an optical element 608 adjacent thereto. Specifically, rather than having the cover include Fresnel lens elements, the cover 604 may be provided without any inherent Fresnel lens elements. The optical element 608 may correspond to a Fresnel lens sheet that is placed on, adhered to, or otherwise attached to the heat sink 504. As with cover 536, the cover 604 may include a transparent or translucent plastic or glass material. Additionally, as with cover 536, the cover 604 may include a bend that results in its bottom surface having a height difference H between its middle sections and ends. Again, the height difference H may be less than or equal to 5.0 mm and more specifically may be less than or equal to 2.5 mm to help direct the light downward as it exits the illumination device 104. In other words, the height difference H may be less than 10 percent of the overall height of the illumination device and/or one half the overall height of the heat sink 504.

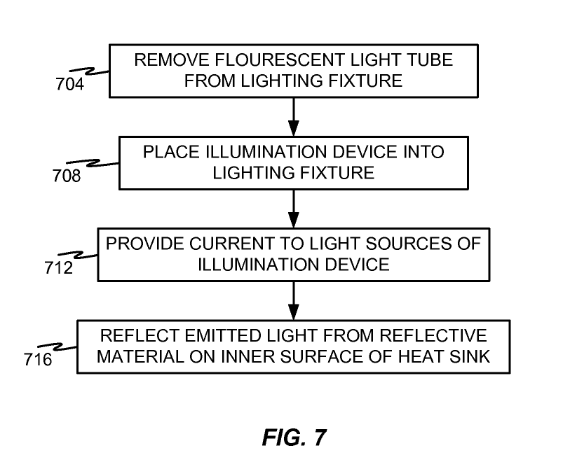

With reference now to FIG. 7, a method installing and using an illumination device 104 in an existing lighting fixture 404 will be described in accordance with at least some embodiments of the present disclosure. The method begins by removing an existing tube-type light element (e.g., fluorescent tube light) from a lighting fixture 404 (step 704). The method continues by placing one or more illumination devices 104 into the lighting fixture 404 (step 708). Thereafter, current or power is selectively provided to light source(s) 532 contained within the illumination device 104 (step 712). The light source(s) 532 are activated in response to receiving electrical current or power and emit light. The emitted light either travels directly out of the illumination device 104 or reflects off one or more reflective walls 520, 524 on the inner surface of the heat sink 504 channel 516 (step 716). This particular method helps to produce a minimal amount of up-light while retaining an installed based of lighting fixtures 404.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. An illumination device, comprising:
an elongated heat sink comprising a first end, a second end, and a body portion therebetween, the body portion including a channel that is defined by at least two walls and a mounting surface positioned between the at least two walls;
one or more light sources mounted in proximity to the mounting surface and configured to emit light away from the mounting surface toward a channel opening that is established at a bottom portion of the elongated heat sink; and
a cover that at least partially spans the channel opening and interfaces with the bottom portion of the elongated heat sink, the cover being at least one of transparent and translucent and comprising a bent profile that focuses light emitted by the one or more light sources, wherein the cover comprises a middle section and two ends, wherein the two ends of the cover interface with the bottom portion of the heat sink and wherein the middle section extends a lateral distance away from the two ends a distance that is less than or equal to approximately 5.0 mm.

2. The device of claim 1, further comprising:
a substrate attached to the mounting surface of the body portion, wherein the one or more light sources are attached to the substrate.

3. The device of claim 2, wherein the one or more light sources comprise at least one of a thru-hole mount Light Emitting Diode (LED) and surface-mount LED.

4. The device of claim 1, wherein the one or more light sources comprise an Organic Light Emitting Diode (OLED) sheet or film.

5. The device of claim 1, wherein the lateral distance is less than or equal to approximately 2.5 mm.

6. The device of claim 1, wherein the lateral distance is less than or equal to 10 percent of a total height of the device.

7. The device of claim 1, wherein the cover comprises one or more Fresnel lens elements.

8. The device of claim 1, further comprising:
a Fresnel lens sheet that is positioned adjacent to a surface of the cover that faces the channel.

9. The device of claim 1, wherein the at least two walls comprise a reflective surface and wherein an angle between the at least two walls is less than 180 degrees.

10. The device of claim 1, further comprising:
one or more pins that provide an electrical connection between the one or more light sources and an external power source.

11. A light fixture, comprising:
a troffer; and
an illumination device mounted in the troffer, the illumination device comprising:
an elongated heat sink comprising a channel, a curved top portion, and a bottom portion, the channel being exposed via the bottom portion, wherein the channel is defined by a first reflective wall, a second reflective wall, and a mounting surface positioned between the first and second reflective walls;
one or more light sources attached to the mounting surface and configured to emit light away from the mounting surface toward a channel opening; and
a cover that connects to the bottom portion of the elongated heat sink and spans the channel opening, the cover being at least one of transparent and translucent and comprising a profile that shapes light emitted by the one or more light sources, wherein the cover comprises a height difference between the connection at the bottom portion of the elongated heat sink and a middle section of the cover, wherein the height difference is less than or equal to approximately 10 percent of a height of the illumination device.

12. The fixture of claim 11, wherein the one or more light sources comprise a plurality of light sources that are mounted across a length of the illumination device in the channel.

13. The fixture of claim 11, wherein the height difference being less than or equal to approximately 5.0 mm.

14. The fixture of claim 11, wherein the cover comprises one or more Fresnel lens elements.

15. The fixture of claim 11, wherein the illumination device comprises a first end having a first pin and a second end having a second pin, the first pin providing an interconnection with the troffer and the second pin providing an interconnection with the troffer.

16. The fixture of claim 11, wherein the heat sink comprises aluminum.

17. An illumination device, comprising:
an elongated heat sink comprising a first end, a second end, and a body portion therebetween, the elongated heat sink also comprising a curved top portion and a bottom portion, the body portion including a channel that is defined by a mounting surface positioned between a first reflective wall and a second reflective wall;
a Printed Circuit Board (PCB) having a first surface and opposing second surface, the first surface being attached to the mounting surface and the opposing second surface facing toward the channel;
one or more light sources mounted to the PCB and configured to emit light away from the opposing second surface of the PCB toward a channel opening that is established at the bottom portion of the elongated heat sink; and
a non-planar cover that covers the channel opening and interfaces with the bottom portion of the elongated heat sink, the non-planar cover being at least one of transparent and translucent and comprising a height difference between its middle section and ends, wherein the height difference is less than or equal to approximately 5.0 mm.

18. The system of claim 17, wherein the height difference is less than or equal to one half a height of the heat sink, wherein the mounting surface is substantially planar, and wherein both the first reflective wall and second reflective wall are substantially planar with an angle between the first reflective wall and second reflective wall being less than 180 degrees.

19. The system of claim 17, wherein the cover comprises one or more Fresnel lens elements.

20. The system of claim 17, wherein the one or more light sources comprise at least one of the following: a plurality of thru-hole mount Light Emitting Diodes (LEDs), a plurality of surface mount LEDs, and an Organic LED (OLED) sheet or film.
